(19) United States
(12) Patent Application Publication
(10) Pub. No.: US 2015/0245409 A1
(43) Pub. Date: Aug. 27, 2015

(54) CARRIER AGGREGATION OVER LTE AND WIFI

(71) Applicant: Broadcom Corporation, Irvine, CA (US)

(72) Inventor: Kamesh Medapalli, San Jose, CA (US)

(21) Appl. No.: 14/627,196

(22) Filed: Feb. 20, 2015

Related U.S. Application Data
(60) Provisional application No. 61/942,831, filed on Feb. 21, 2014.

(51) Int. Cl. H04W 76/04

(52) U.S. Cl. CPC H04W 76/04

(57) ABSTRACT

In some aspects, the disclosure is directed to methods and systems for intelligent aggregation and management of a plurality of network interfaces or connections. An intelligent connection manager may monitor connection and application communication parameters, and can control dynamic distribution, aggregation, or steering of traffic via different connections or pluralities of connections depending on bandwidth, congestion, or other factors. Connection management may be performed without hardware modification, and may handle connections with highly diverse parameters, such as different bandwidth or round trip latencies, different loss rates, different costs or power consumptions, or other factors. Management policies may be applied responsive to per-application and per-connection parameters to control distribution and/or aggregation of application requests and responses via a plurality of network connections.

### RELATED APPLICATIONS

The present application claims priority to and the benefit of and is a nonprovisional application of U.S. Provisional Application No. 61/942,831, entitled “Methods and Systems for Carrier Aggregation over LTE and WiFi,” filed Feb. 21, 2014, the entirety of which is hereby incorporated by reference.

### FIELD OF THE DISCLOSURE

This disclosure generally relates to systems and methods for communications via a plurality of networks, including but not limited to, intelligent aggregation and management of a plurality of network interfaces or connections.

### BACKGROUND OF THE DISCLOSURE

Many computing devices, and in particular mobile computing devices, include a plurality of network interfaces, frequently of diverse types. For example, a typical smartphone may include at least one cellular communication modem and antenna system, such as a global system for mobile communications (GSM) or code division multiple access (CDMA) compliant system; and at least one WiFi communication modem and antenna system, such as an IEEE 802.11x or Bluetooth compliant system. However, in typical practice, only one connection is used at a time: if WiFi is available, then all communications are transferred via the WiFi connection; if WiFi is unavailable, then all communications are transferred via the cellular connection. This results in wasted bandwidth when both connections are available. Furthermore, when the device loses WiFi connectivity, any transport layer communications between the device and other computing devices are severed and must be reestablished via the cellular interface.

The Multipath Transport Control Protocol (MPTCP) introduced by the Internet Engineering Task Force (IETF) as RFC 6824 attempts to bridge these deficiencies by allowing a single transport layer connection to use a plurality of different network, data, or physical layer interfaces; and maintaining transport layer connections even if one network layer connection of a plurality of network layer connections is lost. However, the MPTCP protocol is not intelligent and cannot dynamically steer traffic via different connections depending on bandwidth, congestion, or other factors. In particular, the MPTCP protocol has significant deficiencies handling connections with asymmetric bandwidth or round trip latencies, such as a combination of cellular connections and WiFi connections.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1A is a block diagram depicting an embodiment of a network environment including one or more access points in communication with one or more devices or stations;

FIGS. 1B and 1C are block diagrams depicting embodiments of computing devices useful in connection with the methods and systems described herein;

FIG. 2A is a block diagram depicting an embodiment of a system for intelligent aggregation and management of a plurality of network connections;

FIG. 2B is another block diagram depicting an embodiment of a device configured for intelligent aggregation and management of a plurality of network connections;

FIG. 3A is a flow diagram of an embodiment of a method for intelligent aggregation and management of a plurality of network interfaces;

FIG. 3B is a flow diagram of an embodiment of a method for applying a management policy to control aggregation of a plurality of network interfaces; and

FIG. 3C is a flow diagram of another embodiment of a method for applying a management policy to control aggregation of a plurality of network interfaces.

The details of various embodiments of the methods and systems are set forth in the accompanying drawings and the description below.

### DETAILED DESCRIPTION

The following IEEE standard(s), including any draft versions of such standard(s), are hereby incorporated herein by reference in their entirety and are made part of the present disclosure for all purposes: IEEE P802.11N™; and IEEE P802.11Ac™ Although this disclosure may reference aspects of these standard(s), the disclosure is in no way limited by these standard(s).

For purposes of reading the description of the various embodiments below, the following descriptions of the sections of the specification and their respective contents may be helpful:
Section A describes a network environment and computing environment which may be useful for practicing embodiments described herein; and
Section B describes embodiments of systems and methods for intelligent aggregation and management of a plurality of network interfaces or connections.

### A. Computing and Network Environment

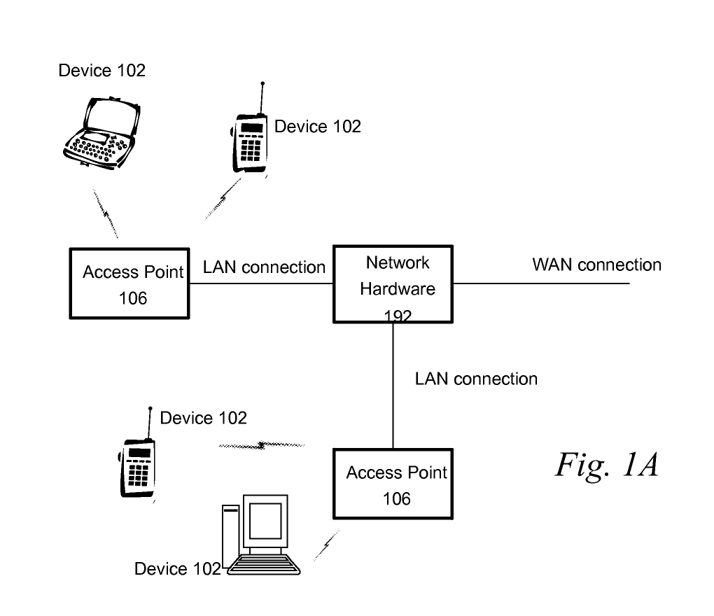

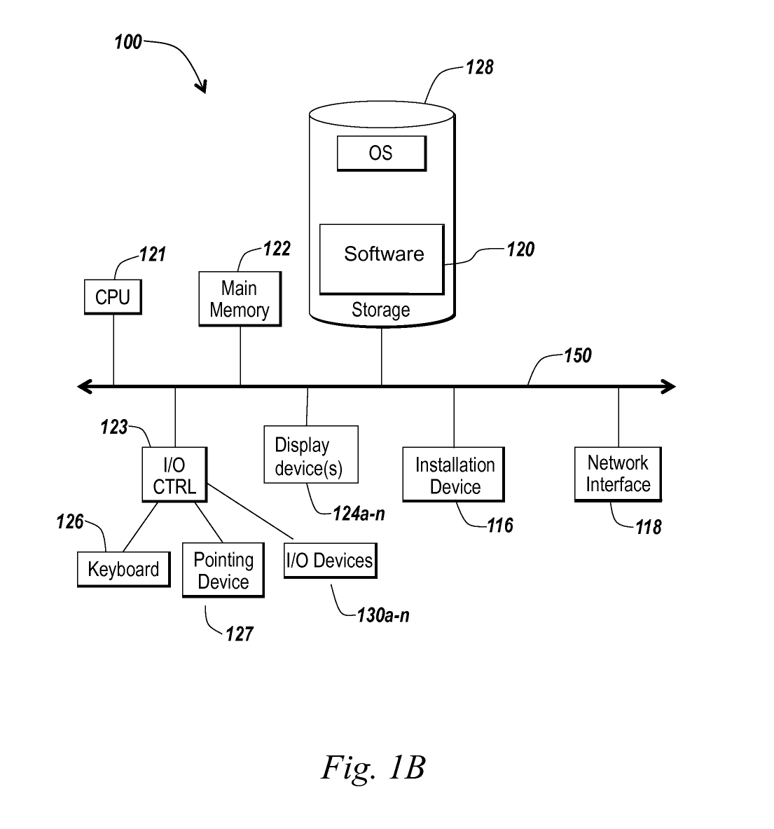

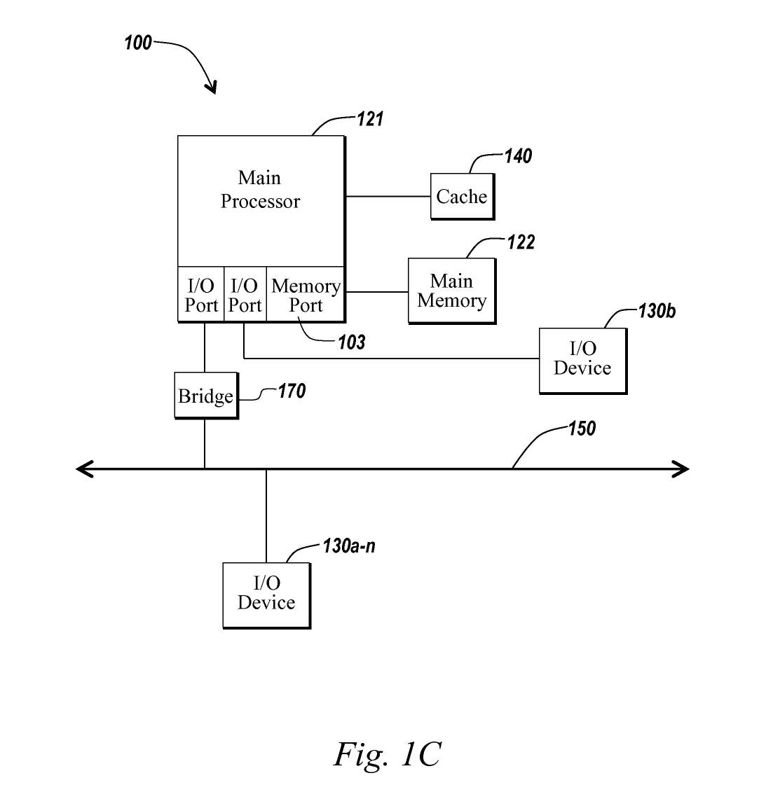

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes a wireless communication system that includes one or more access points 106, one or more wireless communication devices 102 and a network hardware component 192. The wireless communication devices 102 may for example include laptop computers 102, tablets 102, personal computers 102 and/or cellular telephone devices 102. The details of an embodiment of each wireless communication device and/or access point are described in greater detail with reference to FIGS. 1B and 1C. The network environment can be an ad hoc network environment, an infrastructure wireless network environment, a subnet environment, etc. in one embodiment

The access points (APs) 106 may be operably coupled to the network hardware 192 via local area network connections. The network hardware 192, which may include a router, gateway, switch, bridge, modem, system controller, appliance, etc., may provide a local area network connection for the communication system. Each of the access points 106 may have an associated antenna or an antenna array to communicate with the wireless communication devices 102 in its area. The wireless communication devices 102 may register with a particular access point 106 to receive services from the communication system (e.g., via a SU-MIMO or MU-MIMO configuration). For direct connections (e.g., point-to-point communications), some wireless communication devices 102 may communicate directly via an allocated channel and communications protocol. Some of the wireless communication devices 102 may be mobile or relatively static with respect to the access point 106.

In some embodiments an access point 106 includes a device or module (including a combination of hardware and software) that allows wireless communication devices 102 to connect to a wired network using Wi-Fi, or other standards. An access point 106 may sometimes be referred to as an wireless access point (WAP). An access point 106 may be configured, designed and/or built for operating in a wireless local area network (WLAN). An access point 106 may connect to a router (e.g., via a wired network) as a standalone device in some embodiments. In other embodiments, an access point can be a component of a router. An access point 106 can provide multiple devices 102 access to a network. An access point 106 may, for example, connect to a wired Ethernet connection and provide wireless connections using radio frequency links for other devices 102 to utilize that wired connection. An access point 106 may be built and/or configured to support a standard for sending and receiving data using one or more radio frequencies. Those standards, and the frequencies they use may be defined by the IEEE (e.g., IEEE 802.11 standards). An access point may be configured and/or used to support public Internet hotspots, and/or on an internal network to extend the network's Wi-Fi signal range.

In some embodiments, the access points 106 may be used for (e.g., in-home or in-building) wireless networks (e.g., IEEE 802.11, Bluetooth, ZigBee, any other type of radio frequency based network protocol and/or variations thereof). Each of the wireless communication devices 102 may include a built-in radio and/or is coupled to a radio. Such wireless communication devices 102 and/or access points 106 may operate in accordance with the various aspects of the disclosure as presented herein to enhance performance, reduce costs and/or size, and/or enhance broadband applications. Each wireless communication devices 102 may have the capacity to function as a client node seeking access to resources (e.g., data, and connection to networked nodes such as servers) via one or more access points 106.

The network connections may include any type and/or form of network and may include any of the following: a point-to-point network, a broadcast network, a telecommunications network, a data communication network, a computer network. The topology of the network may be a bus, star, or ring network topology. The network may be of any such network topology as known to those ordinarily skilled in the art capable of supporting the operations described herein. In some embodiments, different types of data may be transmitted via different protocols. In other embodiments, the same types of data may be transmitted via different protocols.

The communications device(s) 102 and access point(s) 106 may be deployed as and/or executed on any type and form of computing device, such as a computer, network device or appliance capable of communicating on any type and form of network and performing the operations described herein. FIGS. 1B and 1C depict block diagrams of a computing device 100 useful for practicing an embodiment of the wireless communication devices 102 or the access point 106. As shown in FIGS. 1B and 1C, each computing device 100 includes a central processing unit 121, and a main memory unit 122. As shown in FIG. 1B, a computing device 100 may include a storage device 128, an installation device 116, a network interface 118, an I/O controller 123, display devices 124a-124n, a keyboard 126 and a pointing device 127, such as a mouse. The storage device 128 may include, without limitation, an operating system and/or software. As shown in FIG. 1C, each computing device 100 may also include additional optional elements, such as a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, such as: those manufactured by Intel Corporation of Mountain View, Calif.; those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 121, such as any type or variant of Static random access memory (SRAM), Dynamic random access memory (DRAM), Ferroelectric RAM (FRAM), NAND Flash, NOR Flash and Solid State Drives (SSD). The main memory 122 may be based on any of the above described memory chips, or any other available memory chips capable of operating as described herein. In the embodiment shown in FIG. 1B, the processor 121 communicates with main memory 122 via a system bus 150 (described in more detail below). FIG. 1C depicts an embodiment of a computing device 100 in which the processor communicates directly with main memory 122 via a memory port 103. For example, in FIG. 1C the main memory 122 may be DRDRAM.

FIG. 1C depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is provided by, for example, SRAM, BSRAM, or EDRAM. In the embodiment shown in FIG. 1C, the processor 121 communicates with various I/O devices 130 via a local system bus 150. Various buses may be used to connect the central processing unit 121 to any of the I/O devices 130, for example, a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 may use an Advanced Graphics Port (AGP) to communicate with the display 124. FIG. 1C depicts an embodiment of a computer 100 in which the main processor 121 may communicate directly with I/O device 130b, for example via HYPERTRANSPORT, RAPIDIO, or INFINIBAND communications technology. FIG. 1C also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices include keyboards, mice, trackpads, trackballs, microphones, dials, touch pads, touch screen, and drawing tablets. Output devices include video displays, speakers, inkjet printers, laser printers, projectors and dye-sublimation printers. The I/O devices may be controlled by an I/O controller 123 as shown in FIG. 1B. The I/O controller may control one or more I/O devices such as a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices such as the USB Flash Drive line of devices manufactured by Twintech Industry, Inc. of Los Alamitos, Calif.

Referring again to FIG. 1B, the computing device 100 may support any suitable installation device 116, such as a disk drive, a CD-ROM drive, a CD-R/RW drive, a DVD-ROM drive, a flash memory drive, tape drives of various formats, USB device, hard-drive, a network interface, or any other device suitable for installing software and programs. The computing device 100 may further include a storage device, such as one or more hard disk drives or redundant arrays of independent disks, for storing an operating system and other related software, and for storing application software programs such as any program or software 120 for implementing (e.g., configured and/or designed for) the systems and methods described herein. Optionally, any of the installation devices 116 could also be used as the storage device. Additionally, the operating system and the software can be run from a bootable medium.

Furthermore, the computing device 100 may include a network interface 118 to interface to the network 104 through a variety of connections including, but not limited to, standard telephone lines, LAN or WAN links (e.g., 802.11, T1, T3, 56kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, IEEE 802.11ac, IEEE 802.11 ad, CDMA, GSM, WiMax and direct asynchronous connections). In one embodiment, the computing device 100 communicates with other computing devices 100′ via any type and/or form of gateway or tunneling protocol such as Secure Socket Layer (SSL) or Transport Layer Security (TLS). The network interface 118 may include a built-in network adapter, network interface card, PCMCIA network card, card bus network adapter, wireless network adapter, USB network adapter, modem or any other device suitable for interfacing the computing device 100 to any type of network capable of communication and performing the operations described herein.

In some embodiments, the computing device 100 may include or be connected to one or more display devices 124a-124n. As such, any of the I/O devices 130a-130n and/or the I/O controller 123 may include any type and/or form of suitable hardware, software, or combination of hardware and software to support, enable or provide for the connection and use of the display device(s) 124a-124n by the computing device 100. For example, the computing device 100 may include any type and/or form of video adapter, video card, driver, and/or library to interface, communicate, connect or otherwise use the display device(s) 124a-124n. In one embodiment, a video adapter may include multiple connectors to interface to the display device(s) 124a-124n. In other embodiments, the computing device 100 may include multiple video adapters, with each video adapter connected to the display device(s) 124a-124n. In some embodiments, any portion of the operating system of the computing device 100 may be configured for using multiple displays 124a-124n. One ordinarily skilled in the art will recognize and appreciate the various ways and embodiments that a computing device 100 may be configured to have one or more display devices 124a-124n.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a FibreChannel bus, a Serial Attached small computer system interface bus, a USB connection, or a HDMI bus.

A computing device 100 of the sort depicted in FIGS. 1B and 1C may operate under the control of an operating system, which control scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: Android, produced by Google Inc.; WINDOWS 7 and 8, produced by Microsoft Corporation of Redmond, Wash.; MAC OS, produced by Apple Computer of Cupertino, Calif.; WebOS, produced by Research In Motion (RIM); OS/2, produced by International Business Machines of Armonk, N.Y.; and Linux, a freely-available operating system distributed by Caldera Corp. of Salt Lake City, Utah, or any type and/or form of a Unix operating system, among others.

The computer system 100 can be any workstation, telephone, desktop computer, laptop or notebook computer, server, handheld computer, mobile telephone or other portable telecommunications device, media playing device, a gaming system, mobile computing device, or any other type and/or form of computing, telecommunications or media device that is capable of communication. The computer system 100 has sufficient processor power and memory capacity to perform the operations described herein.

In some embodiments, the computing device 100 may have different processors, operating systems, and input devices consistent with the device. For example, in one embodiment, the computing device 100 is a smart phone, mobile device, tablet or personal digital assistant. In still other embodiments, the computing device 100 is an Android-based mobile device, an iPhone smart phone manufactured by Apple Computer of Cupertino, Calif., or a Blackberry or WebOS-based handheld device or smart phone, such as the devices manufactured by Research In Motion Limited. Moreover, the computing device 100 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

Aspects of the operating environments and components described above will become apparent in the context of the systems and methods disclosed herein.

### B. Intelligent Aggregation and Management of a Plurality of Network Interfaces or Connections

A computing device, such as device 102, may include a plurality of network interfaces, such as one or more wired interfaces (e.g. Ethernet, Universal Serial Bus (USB), IEEE 1394 (Firewire™), etc.); and one or more wireless interfaces (e.g. WiFi (802.11a, 802.11b, 802.11g, 802.11n, 802.11ac, etc.), Bluetooth, CDMA, GSM, Long Term Evolution (LTE), LTE Advanced, High-Speed Packet Access (HSPA) or Evolved HSPA (HSPA+), Wideband CDMA (WCDMA), Enhanced Voice-Data Optimized (EVDO), Worldwide Interoperability for Microwave Access (WiMAX), General Packet Radio Service (GPRS), Enhanced Data Rates for GSM Evolution (EDGE), etc.). While in typical use, the device 102 may use these interfaces separately (e.g. connecting via WiFi when available and a cellular communication standard when WiFi is unavailable), the systems and methods discussed herein allow aggregation of these interfaces to provide greater bandwidth, lower latency, and higher reliability. In particular, many of the methods and systems discussed herein may be implemented without hardware changes in the device 102.

In one aspect, the present disclosure is directed to a method for intelligent aggregation and management of connections. The method includes establishing, by a device for or on behalf of a first application executed by the device, a first connection via a first interface to a destination. The method also includes establishing, by the device for or on behalf of the first application, at least one additional connection via a corresponding at least one additional interface to the destination. The method further includes determining, by a connection manager executed by the device, at least one communication parameter of the first application. The method also includes determining, by the connection manager, at least one connection parameter of each of the first connection and at least one additional connections. The method also includes applying, by the connection manager, a management policy to configure a multipath communication protocol, responsive to the determined at least one communication parameter of the first application and the determined at least one connection parameter of each of the first connection and at least one additional connections.

In some embodiments of the method, applying the management policy further includes configuring the multipath communication protocol to distribute communications of the first application via a plurality of the connections. In a further embodiment, the communication parameter comprises a communication size of the first application; and the method further includes configuring the multipath communication protocol to distribute communications of the first application via the plurality of the connections responsive to a determination that the communication size of the first application exceeds a predetermined threshold. In another further embodiment, the communication parameter comprises a quality of service (QoS) value for the first application; and the method further includes configuring the multipath communication protocol to distribute communications of the first application via the plurality of the connections responsive to a determination that the QoS value for the first application exceeds a predetermined threshold. In a still further embodiment, the communication parameter further comprises a reliability value for the first application; and the method further includes configuring the multipath communication protocol to distribute communications of the first application via the plurality of the connections responsive to a determination that the reliability value for the first application is below a second predetermined threshold.

In some embodiments, the method includes configuring the multipath communication protocol to duplicate communications of the first application via a plurality of the connections. In a further embodiment, the communication parameter further comprises a reliability value for the first application; and the method includes configuring the multipath communication protocol to distribute communications of the first application via the plurality of the connections responsive to a determination that the reliability value for the first application is above a predetermined threshold. In still other embodiments, the method includes configuring the multipath communication protocol to steer communications of the first application via one of the plurality of the connections. In a further embodiment, the communication parameter comprises a communication size of the first application; and the method includes configuring the multipath communication protocol to steer communications of the first application via one of the plurality of the connections responsive to a determination that the communication size of the first application is below a predetermined threshold. In another further embodiment, the communication parameter comprises a quality of service (QoS) value for the first application; and the method includes configuring the multipath communication protocol to steer communications of the first application via one of the plurality of the connections responsive to a determination that the QoS value for the first application is below a predetermined threshold.

In another aspect, the present disclosure is directed to a system for intelligent aggregation and management of connections. The system includes a device comprising a processor and a plurality of network interfaces, the processor configured for executing a first application and a connection manager. The device is configured for establishing, for or on behalf of the first application, a first connection via a first interface of the plurality of network interfaces to a destination, and establishing, for or on behalf of the first application, at least one additional connection via a corresponding at least one additional interface of the plurality of network interfaces to the destination. The connection manager is configured for determining at least one communication parameter of the first application, and determining at least one connection parameter of each of the first connection and at least one additional connections. The connection manager is also configured for applying a management policy to configure a multipath communication protocol, responsive to the determined at least one communication parameter of the first application and the determined at least one connection parameter of each of the first connection and at least one additional connections.

In one embodiment of the system, the connection manager is further configured for configuring the multipath communication protocol to distribute communications of the first application via a plurality of the connections. In another embodiment of the system, the connection manager is further configured for configuring the multipath communication protocol to steer communications of the first application via one of the plurality of the connections.

In one embodiment, the communication parameter comprises a communication size of the first application; and the connection manager is further configured for configuring the multipath communication protocol to distribute communications of the first application via a plurality of the connections responsive to a determination that the communication size of the first application exceeds a predetermined threshold. In another embodiment, the communication parameter comprises a quality of service (QoS) value for the first application; and the connection manager is further configured for configuring the multipath communication protocol to distribute communications of the first application via a plurality of the connections responsive to a determination that the QoS value for the first application exceeds a predetermined threshold. In a further embodiment, the communication parameter further comprises a reliability value for the first application; and the connection manager is further configured for configuring the multipath communication protocol to distribute communications of the first application via the plurality of the connections responsive to a determination that the reliability value for the first application is below a second predetermined threshold.

In some embodiments of the system, the communication parameter further includes a reliability value for the first application; and the connection manager is further configured for configuring the multipath communication protocol to distribute communications of the first application via a plurality of the connections responsive to a determination that the reliability value for the first application is above a predetermined threshold. In other embodiments, the communication parameter comprises a communication size of the first application; and the connection manager is further configured for configuring the multipath communication protocol to steer communications of the first application via one of the plurality of the connections responsive to a determination that the communication size of the first application is below a predetermined threshold. In still other embodiments, the communication parameter comprises a quality of service (QoS) value for the first application; and the connection manager is further configured for configuring the multipath communication protocol to steer communications of the first application via one of the plurality of the connections responsive to a determination that the QoS value for the first application is below a predetermined threshold. In yet still other embodiments, the first connection comprises a cellular connection, such as an LTE connection, 3G connection, or any other type of cellular connection. The second connection comprises a wireless connection, such as an 802.11 or WiFi connection, a BLUETOOTH connection, a wireless universal serial bus (USB) connection, or any other type and form of wireless connection.

In still another aspect, the present application is directed to a system for intelligent aggregation and management of connections. The system includes a cellular communication interface; a wireless communication interface; and circuitry. The circuitry is configured to establish a first connection via the cellular communication interface with an application executed by a remote device; establish a second connection via the wireless communication interface with the application executed by the remote device; and communicate via the first connection and second connection with the application executed by the remote device according to a multipath communication policy selected according to at least one communication parameter of the first application. In some implementations, the circuitry is further configured to distribute communications with the application between the first connection and second connection responsive to a determination that (i) a communication size of the application exceeds a predetermined threshold, or (ii) a communication quality of service (QoS) value of the application exceeds a second predetermined threshold and a communication reliability value of the application is below a third predetermined threshold.

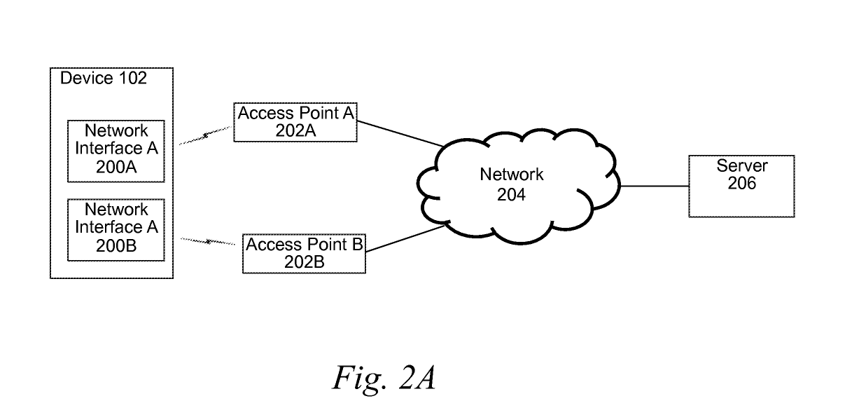

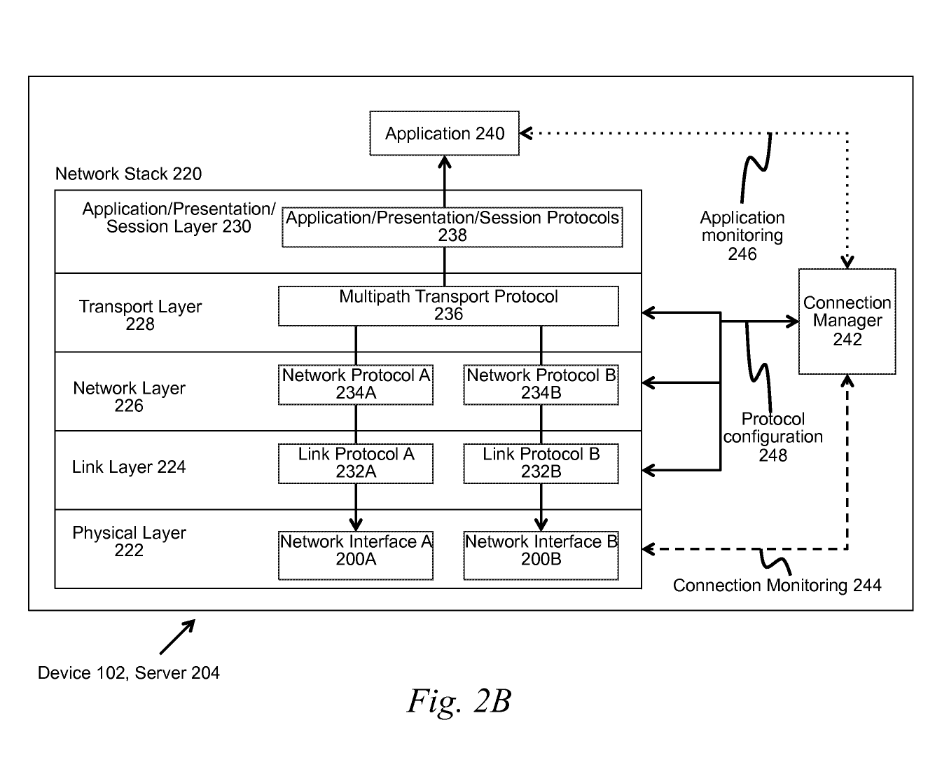

FIG. 2A is a block diagram depicting an embodiment of a system for intelligent aggregation and management of a plurality of network interfaces. As shown, a device 102, such as a mobile computing device, desktop computing device, laptop computing device, tablet computing device, workstation, server, wearable computing device, or other device such as those discussed above, may comprise a plurality of network interfaces 200A, 200B, referred to generally as a network interface 200. Although only two network interfaces 200A-200B are illustrated, in many embodiments, a device 102 may have more network interfaces 200. For example, a device 102 may have an Ethernet wired network interface 200; a USB wired network interface; a WiFI or 802.11x network interface 200; a Bluetooth wireless network interface 200; a nearfield communication wireless network interface 200; and/or any other type of network interface 200 or combination of these or other network interfaces 200.

Each network interface 200 may connect via a corresponding access point 202A-202B, referred to generally as an access point 202, to a network 204 to communication with a server 206 and/or another device 102 (not illustrated). Each access point 202 may be of a type of access point corresponding to a network interface 200. For example, a wired network interface 200 may connect to a wired access point 202, such as an Ethernet switch or router; a wireless 802.11n network interface 200 may connect to an 802.11n WiFi access point 202; or a wireless HSPA+ cellular network interface 200 may connect to an HSPA+ cellular transmitter/receiver 202. Accordingly, an access point 202 may comprise any type and form of hardware for receiving and transmitting communications in a form usable by a corresponding network interface 200. In many implementations, an access point 202 may comprise a router, switch, hub, firewall, load balancer, performance enhancing proxy (PEP), network address translator (NAT), gateway, or any other type and form of network intermediary device, and/or may connect to one or more such devices.

Network 204 may comprise any type and form of network, including a local area network (LAN), metropolitan area network (MAN), wide area network (WAN) such as the Internet, satellite uplink/downlink, or any other type and form of network. Although shown as a single network 204, in many embodiments, network 204 may comprise a combination of several networks 204, such as a first LAN network 204 connected via a gateway 202 to a WAN network 204, connected via a second gateway 202 to a second LAN network 204.

Device 102 may communicate via access points 202 and network(s) 204 to one or more servers 206 or other devices 102. A server 206 may comprise one or more computing devices, including a server farm, cloud, array, or cluster of computing devices, and/or one or more other devices 102. For example, in some implementations, a first device 102 may communicate via access points 202 and network(s) 204 to another device 102.

As with device 102, in some embodiments, server 206 and/or other devices 102 may also comprise a plurality of network interfaces 200. Such network interfaces 200 may accordingly communicate via a corresponding plurality of access points 202. For example, in one such implementation, device 102 may communicate with server 206 via a network interface 200A of device 102, access point 202A, a network 204, another access point 202, and a first network interface 200 of server 206; and also communicate with server 206 via a second network interface 200B, access point 202B, network 204 (or another network 204), yet another access point 202, and a second network interface 200 of server 206. Communications may be distributed via these two (or more) connections depending on one or more management policies, discussed in more detail below. Accordingly, in many implementations, increased speed and/or reliability may be achieved through use of a plurality of network interfaces 200. In other implementations, communications transmitted by device 102 via a plurality of network interfaces 200 may be received by a single network interface of a server 206 and merged or aggregated to create a single data stream. For example, in one such implementation, a first portion of packets may be transmitted by a first network interface 200A and a second portion of packets may be transmitted by a second network interface 200B. Both portions of packets may be received by a single network interface 200 of a server 206, and assembled or multiplexed into a single stream for processing by an application of the server 206. Similarly, communications may flow in the opposite direction, from one or more interfaces of server 206 to a plurality of network interfaces 200 of a device 102 and be merged or aggregated into a single stream for processing by an application of device 102.

FIG. 2B is another block diagram depicting an embodiment of a device 102 or server 204 configured for intelligent aggregation and management of a plurality of network interfaces. Device 102 or server 204 may comprise any type and form of computing device including device 100 discussed above, and may accordingly comprise one or more processors or CPUs 121, memory 122 or 128, display devices 124, interface devices 126-127 or 130, etc. Device 102 or server 204 may also comprise a protocol suite or network stack 220, which may be abstracted as having a plurality of layers 222-230 according to the Open Systems Interconnection (OSI) model (ISO/IEC 7498-1). For example, the network stack 220 may comprise a physical layer 222, link layer 224, network layer 226, transport layer 228, and one or more of a session layer, presentation layer, and/or application layer 230.

Each layer 222-230 of a network stack 220 may implement one or more protocols or interfaces. A physical layer 222 may comprise one more network interfaces 200, including wired and/or wireless network interfaces as discussed above. In many implementations, a first network interface A 200A may comprise a WiFi interface, such as an 802.11n modem and antenna, and a second network interface B 200B may comprise a cellular interface, such as a GSM modem and antenna. Although only two network interfaces 200 are illustrated, in many implementations, a device 102 or server 204 may comprise a greater or fewer number of interfaces 200. In implementations in which a device 102 or server 204 comprises a plurality of physical layer interfaces, each interface 200 may or may not have identical network parameters, such as bandwidth or bitrate, latency, round trip communications time, congestion levels, packet loss rates, signal to noise ratios, maximum transmission unit (MTU) sizes, buffer sizes, window sizes, or other such parameters.

The network stack 220 may comprise one or more link protocols 232A-232B, referred to generally as link protocol(s) 232 at the link layer 224. In many implementations, as shown, the network stack 220 may comprise one link protocol 232 for each network interface 200. In other implementations, a plurality of link protocols 232 may be communicated via a single network interface 200, or a single link protocol 232 may be communicated via a plurality of network interfaces 200. Link protocols 232 may comprise any type and form of data link layer 224 protocols, including Ethernet, Point-to-Point Protocol (PPP), Asynchronous Transfer Mode (ATM) protocol, IEEE 802.11 wireless LAN protocol, or any other type and form of link protocol 232. As with physical layer interfaces, each link protocol 232 may or may not have identical network parameters, such as bandwidth or bitrate, latency, round trip communications time, congestion levels, packet loss rates, signal to noise ratios, maximum transmission unit (MTU) sizes, buffer sizes, window sizes, or other such parameters.

The network stack 220 may comprise one or more network protocols 234A-234B, referred to generally as network protocol(s) 234 at the network layer 226. In many implementations, as shown, the network stack 220 may comprise one network protocol 234 for each link protocol 232. In other implementations, a plurality of network protocols 234 may be communicated via a single link protocol 232, or a single network protocol 234 may be communicated via a plurality of link protocols 232. Network protocols 234 may comprise any type and form of network layer 226 protocols, including Internet Protocol version 4 (IPv4), IP version 6 (IPv6), Internet Control Message Protocol (ICMP), Internet Protocol Security (IPSec), Address Resolution Protocol (ARP), Internetwork Packet Exchange (IPX) protocol, or any other type and form of network protocol 234. As with link layer interfaces, each network protocol 234 may or may not have identical network parameters, such as bandwidth or bitrate, latency, round trip communications time, congestion levels, packet loss rates, signal to noise ratios, maximum transmission unit (MTU) sizes, buffer sizes, window sizes, or other such parameters.

The network stack 220 may comprise one or more transport layer protocols 236, referred to generally as transport protocol(s) 236 at the transport layer 228. In many implementations, as shown, the network stack 220 may comprise one transport protocol 236 for a plurality of network protocols 234. For example, a transport protocol 236 may comprise a multipath transport control protocol (MPTCP) or similar transport control protocol allowing transmission of packets of a single transport layer session via a plurality of network protocols 234 and/or network interfaces 200. In many implementations, the multipath transport protocol 236 may comprise functionality for numbering packets for ordered assembly regardless of which network interface and/or network connection they are transmitted, such as a transport layer sequence number; as well as functionality for numbering packets for ordered assembly of each sub-transmission of packets via different network protocols and/or network interfaces, such as per-network or sub-flow sequence numbers. In addition to being used for reassembling received packets in the original transmission order, sequence numbers or sub-flow sequence numbers may be used for retransmission and congestion control algorithms, link loss detection algorithms, or other such features.

The network stack 220 may comprise one or more application, presentation, and/or session layer protocols 238 at the application, presentation, and/or session layer 230. For example, the network stack 220 may include an independent computing architecture (ICA) protocol 238 at a presentation layer 230 for transmission of hypertext transfer protocol (HTTP) data at an application layer 230′ between a client and remote host. Accordingly, one of skill in the art may readily appreciate that layer 230 may comprise a plurality of protocols. As shown, the application, presentation, and/or session layer 230 protocols may be communicated via the multipath transport protocol 236, which may distribute packets via one or more network protocols 234.

A device 102 or server 204 may execute one or more applications 240. Applications 240 may comprise applications, servers, daemons, applets, routines, or other executable logic for performing one or more functions and communicating via a network stack 220 with another device 102 and/or server 204. For example, an application 240 may comprise an email application, a web browser application, a remote update application, a Voice-over-IP (VoIP) application, a video conferencing application, a video game, a media display application, a remote database application, an interface to a cloud-based application, or any other type and form of application. Applications 240 may transmit and receive data to and from the network stack 220 via one or more application programming interfaces (APIs) or other such interfaces. In many implementations, applications 240 may not be aware of or be agnostic to various protocols or interfaces 200, 232-238 utilized by the network stack 220. For example, a web browser application 240 may transmit requests and receive responses to and from a network stack 220 to communicate with web servers, without knowledge or regard for whether the communications are sent via HTTP and transport layer protocol (TCP)/IPv4 over a wired Ethernet network interface, or via secure HTTP (HTTPS) and user datagram protocol (UDP)/IPv6 via a wireless 802.11 ac network interface. In particular, an application 240 may transmit and receive data transmitted via a plurality of network interfaces 200 via a multipath transport protocol 236 without knowledge that the data is not communicated via a single network interface. Accordingly, in many aspects, the systems and methods of the present solution may operate transparently and seamlessly to one or more applications 240, and applications may not be required to be modified to utilize the benefits of intelligent multipath distribution and aggregation. Distribution and aggregation/reassembly of data streams may be performed within the network stack 220, such as at the transport layer 228, and thus a single data connection or socket may be presented to an application 240. In other implementations, applications may be multipath connection-aware or may explicitly communicate with a connection manager, for example, to provide explicit aggregation or distribution instructions.

Although only one application 240 is illustrated, in many implementations, a plurality of applications 240 may be executed by a device 102 or server 204. Each application 240 may communicate separately with the network stack 220, and data streams from or to each application 240 may be distributed or aggregated via a plurality of network interfaces 200.

A device 102 or server 204 may also execute a connection manager 242. A connection manager 242 may comprise an application, server, service, daemon, routine, or other executable logic for monitoring one or more network interfaces 200, shown as interface monitoring 244 in dashed line; monitoring one or more applications 240, shown as application monitoring 246 in dotted line; and/or configuring one or more protocols 232-236 or controlling distribution and aggregation of data via protocols 232-236. In some implementations, a connection manager 242 may intercept and process packets transmitted up and down the network stack 220, while in other implementations, connection manager 242 may receive protocol and interface information from the network stack 220.

Connection manager 242 may monitor one or more network connections via connection monitoring 244. Connection monitoring 244 may comprise monitoring one or more parameters of a network connection, including bandwidth or bitrate, latency, round trip communications time, congestion levels, packet loss rates, signal to noise ratios, maximum transmission unit (MTU) sizes, buffer sizes or fullness, window sizes, or other such parameters. Although shown connected to physical layer 222, in many implementations, connection manager 242 may monitor connections at a higher layer of the network stack. For example, in many implementations, connection manager 242 may monitor connections at the network layer 226. Such monitoring may occur at a level just below merger or aggregation of network connections, such as the aggregation at the transport layer as shown in FIG. 2B.

Connection manager 242 may monitor one or more applications 240 via application monitoring 246. Application monitoring 246 may comprise monitoring one or more parameters of communications from or to the application, including request and/or response sizes, average request and/or response sizes, processing delays, whether an application is in the foreground or background, process or task priority, required quality of service of communications, required average and/or burst bandwidth of communications, required reliability of communications, or any other such parameters. In some implementations, connection manager 242 may monitor an application 240 via APIs associated with the application 240, while in other implementations, connection manager 242 may monitor an application 240 by intercepting or monitoring data transmitted between the application and the network stack 220 or monitoring packet processing at the application layer 230. Such latter implementations may not require modification of an application 240 to enable monitoring 246.

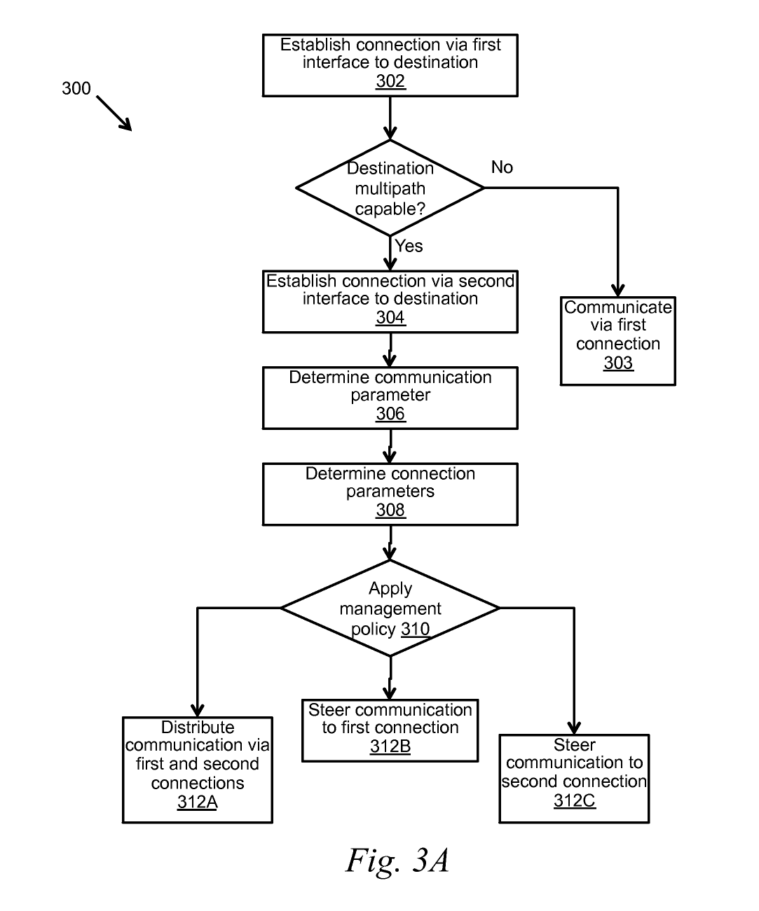

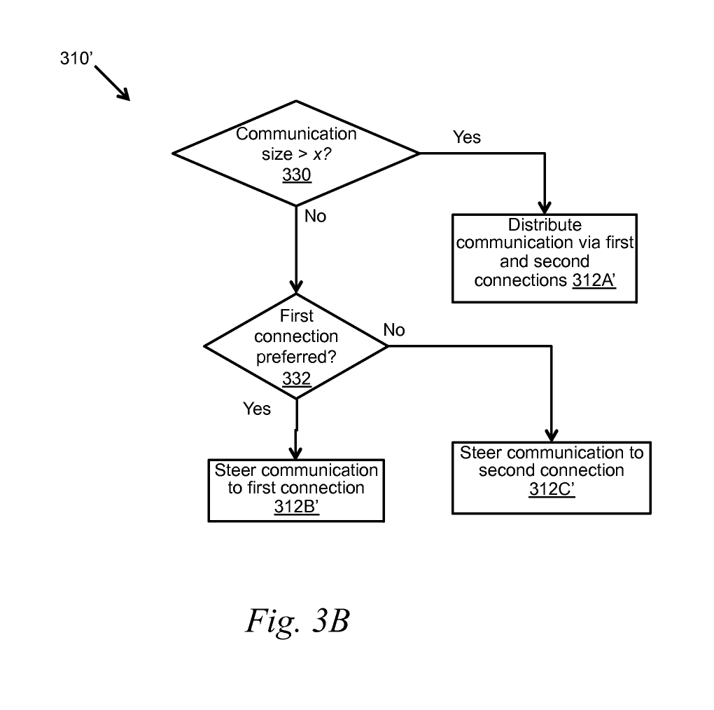

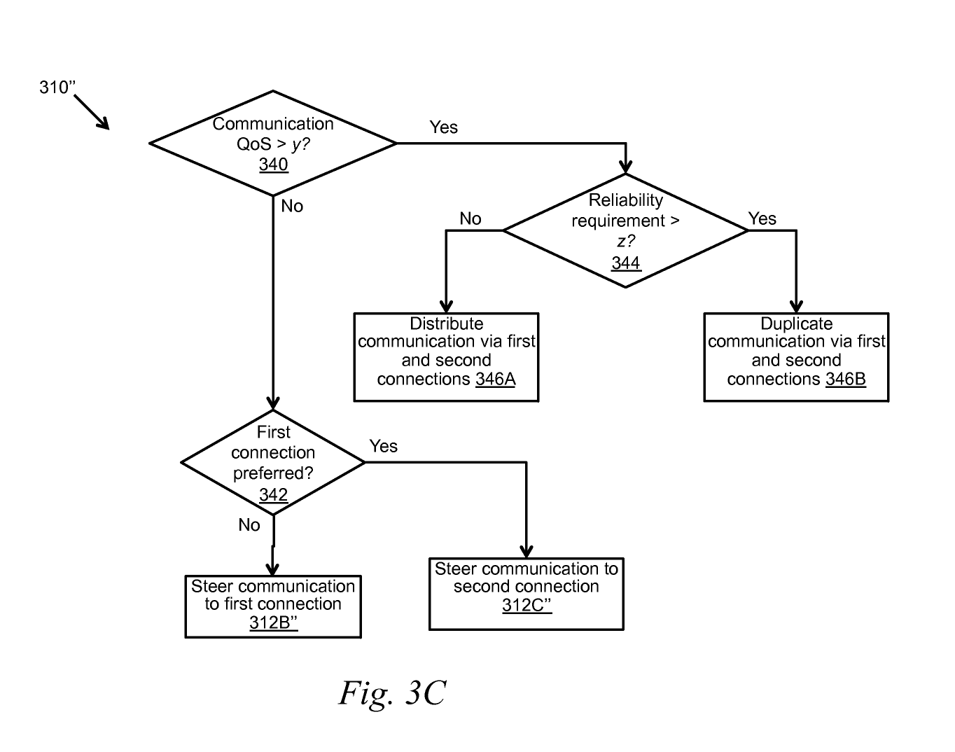

Based on one or both of application monitoring 246 and connection monitoring 244, a connection manager 242 may apply one or more management policies to adjust distribution of packets via a plurality of connections and/or adjust parameters of a multipath transport protocol 236 and/or network or link layer protocols. In some implementations, management policies (referred to generally as policies), discussed in more detail below in connection with FIGS. 3B and 3C, may include determining that an application requires as high a bandwidth as possible, and configuring a multipath transport control 236 to distribute packets of the application across the plurality of network interfaces; or determining that the application requires high reliability of communications, and configuring the multipath transport control 236 to retransmit or duplicate packets across the plurality of network interfaces to reduce the likelihood of packet losses. In other implementations, management policies may include determining that a particular connection is unsuitable or not preferred for communications of an application, for example, due to cost, battery usage, latency, slow start algorithms, or other features, and may configure the multipath transport protocol 236 to direct packets of the application via another connection. Accordingly, management policies may be applied responsive to per-application and per-connection parameters to control distribution and/or aggregation of application requests and responses via a plurality of network connections.

In some embodiments in which communications are distributed across a plurality of network interfaces or connections, communications may be evenly divided amongst the connections (e.g. 50% to each connection in implementations with two connections, 33% to each connection in implementations with three connections, etc.). In other embodiments, communications may be apportioned amongst the connections responsive to one or more connection parameters. For example, if a first connection has 9 times the bandwidth of a second connection, communications may be apportioned with 90% of the communications via the first connection and 10% via the second connection. In another example, if a first connection is experiencing a high rate of congestion events or packet losses, the connection manager may direct the multipath transport protocol to direct a large percentage of communications via the second (or further) connections until congestion has abated or the loss rate declines on the first connection.

FIG. 3A is a flow diagram of an embodiment of a method 300 for intelligent aggregation and management of a plurality of network interfaces. In brief overview, at step 302, a device may establish a connection via a first interface to a destination. The device may determine if the destination is multipath-capable. If not, then at step 303, the device may communicate with the destination via the first interface. If the destination is multipath-capable, then at step 304, the device may establish a connection via a second interface to the destination. At step 306, a connection manager of the device may determine one or more communications parameters of an application of the device. At step 308, the connection manager may determine one or more connection parameters of the connection via the first interface and of the connection via the second interface. At step 310, the connection manager may apply one or more management policies, based on the determined communications parameters and/or connection parameters, and configure one or more protocols to apply the policy directives. Responsive to the configuration, the device may distribute communications via the first and second interfaces at step 312A, may steer communications to the first interface 312B, or may steer communications to the second interface 312C.

Still referring to FIG. 3A and in more detail, at step 302, the device may establish a connection via a first interface to a destination. The destination may comprise another device, a server, an intermediary device or appliance, or any other destination. The connection may be established responsive to a request from an application on the device, such as a request from a web browser to retrieve a web page from a server, or may be established responsive to a request of the destination. Establishment of the first connection may comprise performing a handshaking algorithm, such as the three-way handshake of TCP or MPTCP, and may include synchronizing sequence numbers for the connection, as discussed above.

The device may determine if the destination is multipath-capable. In some embodiments, detecting whether the destination is multipath-capable may comprise transmitting a synchronization or synchronization acknowledgement packet with a predetermined option set to indicate that the sender is multi-path capable and receiving a corresponding acknowledgement from the destination indicating that the destination is multipath-capable, or vice versa. In other implementations, the device may transmit a request to establish a second connection to be aggregated with the first request and determine whether the destination is multipath-capable based on the response from the destination. If the destination is not multipath-capable, then at step 303, the device may continue communications with the destination via the first interface.

If the destination is multipath-capable, then at step 304, the device may establish a connection via a second interface to the destination. Establishing the second connection may comprise a similar process as establishing the first connection, including performing handshaking and synchronization algorithms. In many implementations, establishing the second connection may comprise setting sub-flow or per-connection sequence numbers for each of the first connection and second connection, separate from the sequence number for the overall communication. Although discussed in terms of a first and second connection, in some implementations, a greater number of connections may be established at step 304.

At step 306, a connection manager of the device may determine communication parameters of the application communicating via the first and second (or further) interfaces. Communication parameters of the application may comprise average, minimum, and/or maximum request and/or response sizes; average, minimum, and/or maximum processing times of requests before transmission of responses; application latency, reliability, or Quality of Service (QoS) requirements; whether a window of the application is in the foreground or background of a windowing system (i.e. z-order of windows of the application); process priority of the application; memory usage of the application; buffer sizes or fullness of the application; or any other such parameters. Communication parameters may be measured dynamically, such as via monitoring or hooking an API used by the application to communicate with the network stack or by intercepting and parsing communications between the application and network stack; monitoring and/or intercepting communications at the application, session, and/or presentation layer; or any other such methods. In other implementations, communication parameters may be predetermined and retrieved from a database. For example, QoS, latency, and reliability parameters may be set based on application type, with a VoIP application requiring a higher QoS and lower latency than an email application, or based on any other such feature of the application.

In many implementations, the second (or further) connection may be via a different network interface, access point, or path from the first connection. Accordingly, the second connection may have different connection parameters from the first connection. At step 308, the connection manager may determine the connection parameters of each connection. Determining the connection parameters may comprise retrieving one or more parameters from a network stack of the device, such as buffer or window sizes or notifications of congestion events, or may comprise performing one or more measurements on a connection, such as average bandwidth, latency, round trip times, packet loss rates, or other measurements. In some implementations, determining a connection parameter may comprise identifying a connection type and retrieving a predetermined parameter value from a database. For example, a connection such as a cellular connection have a predetermined cost per byte transferred, or may have a predetermined power consumption per packet. In other implementations, values such as power consumption or signal to noise ratios may be dynamically determined, for example, by communicating with an operating system or hardware controller of the device. Although shown after step 306, in many implementations, connection parameters may be determined before communication parameters, or in parallel with such determinations.

At step 310, the connection manager may apply one or more management policies, based on the determined communications parameters and/or connection parameters, and configure one or more protocols to apply the policy directives. For example, the connection manager may determine a required level of reliability of communications of an application, and if the required level exceeds a threshold, may configure a multipath transport protocol to duplicate packets of the application via multiple connections, to increase the likelihood of successful transmission (e.g. responsive to the configuration, the device may distribute communications via the first and second interfaces at step 312A). Similarly, in some implementations, if the connection manager determines that an application has an average request or response size above a threshold, the connection manager may configure the multipath transport protocol to distribute communications of the application across the plurality of connections to aggregate the bandwidth and achieve the highest possible overall data rate (e.g. also distributing communications via the first and second interfaces at step 312A). Conversely, in some embodiments, if the connection manager determines that the average request or response size is below a threshold, the connection manager may configure the multipath transport protocol to steer the communications of the application to the faster of either the first or second interface (e.g. step 312B or 312C respectively). Due to slow-start or congestion avoidance algorithms, this may be more efficient than distributing short communications via multiple connections. Similarly, if the connection manager determines that an application has low priority communications (e.g. an email application or a file transfer), the connection manager may configure the multipath transport protocol to steer the communications of the application to the slower of either the first or second interface (e.g. step 312B or 312C respectively). This may free up bandwidth of the faster interface for higher priority application communications. In other implementations, the connection manager may configure the multipath transport layer protocol to avoid using one interface for anything but high priority or short communications, responsive to high data costs, congestion, or power consumption of the connection or interface associated with the connection, or other such considerations.

Although discussed in terms of a single application, method 300 may be repeated for a plurality of applications. The connection manager may make apply different management policies for each application, responsive to different communications parameters of each application (e.g. a VoIP application requiring lower latency than an email application) and/or responsive to changing connection parameters (e.g. a first access point experiencing a high packet loss rate).

FIG. 3B is a flow diagram of an embodiment of a method 310′ for applying a management policy to control aggregation of a plurality of network connections. At step 330, the connection manager may determine if an average, minimum, or maximum communication size of an application exceeds a threshold x. If the size exceeds the threshold, then in some implementations, the connection manager may configure the multipath transport protocol to distribute communications of the application via a plurality of connections at step 312A′, aggregating a higher bandwidth for the communications than any individual connection. The threshold x may be predetermined or configured by an administrator, or may be dynamically determined, such as based on a slow start algorithm or current window size of a connection. For example, as the window size increases, larger communications may not need to be aggregated in some implementations, but may be sent via a single connection.

If the average, minimum, or maximum communication size of the application does not exceed the threshold x, then in some implementations, the connection manager may determine at step 332 whether a first interface of a plurality of interfaces is preferred for the communication. In some implementations, a first interface may be preferred if said first interface is faster or has a higher bandwidth than other interfaces (particularly if the communication size is large, even if the communication size does not exceed the threshold x); if said first interface has a lower latency or round trip time than other interfaces; if said first interface has a higher reliability, lower noise rate or packet loss rate than other interfaces; if said first interface incorporates hardware or software encryption (e.g. a network connection via a virtual private network (VPN) or an IPSec protocol); if said first interface has a lower data cost than other interfaces or a higher periodic data limit (e.g. a monthly data cap); if said first interface has a lower power consumption than other interfaces; or any other such features or combinations of features. In one implementation, the connection manager may generate a score for each connection based on one or more connection parameters, with a highest scoring connection being considered “preferred”. If the first connection is preferred, then the connection manager may configure the multipath protocol to steer communications of the application to the first connection at step 312B′. If the first connection is not preferred, then the connection manager may configure the multipath protocol to steer communications of the application to the second connection at step 312C′. Although only two connections are illustrated, one of skill in the art may readily appreciate that the connection manager may select a preferred connection from a plurality of connections, including three, four, five, or any other number of connections, for example, based on scores for each connection as discussed above.

FIG. 3C is a flow diagram of another embodiment of a method 310″ for applying a management policy to control aggregation of a plurality of network interfaces. At step 340, the connection manager may determine if an application or communication parameter requires a QoS above a threshold y. QoS may comprise reliability requirements, maximum latency requirements, maximum packet loss requirements, or other such features. If the communication parameter requires a QoS above a threshold y, then in some implementations, the connection manager may determine at step 344 if the communication parameter requires a reliability requirement above a threshold z. If the communication parameter requires a reliability requirement above a threshold z, then the connection manager may configure the multipath transport protocol to duplicate communications via a plurality of connections at step 346B, providing reliability in case of packet loss or connection dropout. If not, then the connection manager may configure the multipath transport protocol to distribute communications between the plurality of connections at step 346A, providing a higher aggregated bandwidth than any individual connection. As discussed above in connection with threshold x, thresholds y and z may be preconfigured or may be dynamically determined responsive to one or more changing connection parameters.

If the communication QoS requirement is below threshold y, then at step 342, the connection manager may determine whether a first connection is preferred, as discussed above in connection with step 332 of FIG. 3B. If the first connection is preferred, then the connection manager may configure the multipath transport protocol to steer communications to the first connection at step 312B″; if the first connection is not preferred (or if another connection is preferred), then the connection manager may configure the multipath transport protocol to steer communications to the second (or further) connection at step 312C″.

Although shown separately for clarity, in many implementations, methods 310′ and 310″ may be combined, with the connection manager applying policies for QoS, reliability, connection preference, and/or communication size in series or parallel. For example, in one such implementation, the connection manager may apply policies for communication size compared to threshold x; and QoS requirement compared to threshold y, such that if either communication parameter exceeds the corresponding threshold, the connection manager may direct the multipath transport protocol to distribute communications via the plurality of connections. In another implementation, the connection manager may generate a score for the communication, increasing the score by an amount proportional to the QoS level and/or communication size, and compare the score to a threshold to determine if communications should be distributed across a plurality of connections. For example, large size but low QoS communications, or high QoS and small size communications, may have a score exceeding said threshold and be distributed to the plurality of connections; conversely, moderate sized and moderate QoS communications may not exceed the threshold, and may be steered to a preferred connection.

Accordingly, via the systems and methods discussed herein, an intelligent connection manager may monitor connection and application communication parameters, and can control dynamic distribution, aggregation, or steering of traffic via different connections or pluralities of connections depending on bandwidth, congestion, or other factors. Connection management may be performed without hardware modification, and may handle connections with highly diverse parameters, such as different bandwidth or round trip latencies, different loss rates, different costs or power consumptions, or other factors.

Although the disclosure may reference one or more “users”, such “users” may refer to user-associated devices or stations (STAs), for example, consistent with the terms “user” and “multi-user” typically used in the context of a multi-user multiple-input and multiple-output (MU-MIMO) environment.

Although examples of communications systems described above may include devices and APs operating according to an 802.11 standard, it should be understood that embodiments of the systems and methods described can operate according to other standards and use wireless communications devices other than devices configured as devices and APs. For example, multiple-unit communication interfaces associated with cellular networks, satellite communications, vehicle communication networks, and other non-802.11 wireless networks can utilize the systems and methods described herein to achieve improved overall capacity and/or link quality without departing from the scope of the systems and methods described herein.

It should be noted that certain passages of this disclosure may reference terms such as “first” and “second” in connection with devices, mode of operation, transmit chains, antennas, etc., for purposes of identifying or differentiating one from another or from others. These terms are not intended to merely relate entities (e.g., a first device and a second device) temporally or according to a sequence, although in some cases, these entities may include such a relationship. Nor do these terms limit the number of possible entities (e.g., devices) that may operate within a system or environment.

It should be understood that the systems described above may provide multiple ones of any or each of those components and these components may be provided on either a standalone machine or, in some embodiments, on multiple machines in a distributed system. In addition, the systems and methods described above may be provided as one or more computer-readable programs or executable instructions embodied on or in one or more articles of manufacture. The article of manufacture may be a floppy disk, a hard disk, a CD-ROM, a flash memory card, a PROM, a RAM, a ROM, or a magnetic tape. In general, the computer-readable programs may be implemented in any programming language, such as LISP, PERL, C, C++, C#, PROLOG, or in any byte code language such as JAVA. The software programs or executable instructions may be stored on or in one or more articles of manufacture as object code.

While the foregoing written description of the methods and systems enables one of ordinary skill to make and use what is considered presently to be the best mode thereof, those of ordinary skill will understand and appreciate the existence of variations, combinations, and equivalents of the specific embodiment, method, and examples herein. The present methods and systems should therefore not be limited by the above described embodiments, methods, and examples, but by all embodiments and methods within the scope and spirit of the disclosure.

We claim:

1. A method for intelligent aggregation and management of connections, comprising:
establishing, by a device for a first application executing on the device, a first connection via a first interface to a destination;
establishing, by the device for the first application, at least one additional connection via a corresponding at least one additional interface to the destination;
determining, by a connection manager executing on the device, at least one communication parameter of the first application;
determining, by the connection manager, at least one connection parameter of each of the first connection and at least one additional connections; and
applying, by the connection manager, a policy to configure a multipath communication protocol, responsive to the determined at least one communication parameter of the first application and the determined at least one connection parameter of each of the first connection and at least one additional connections.

2. The method of claim 1, wherein applying the policy further comprises configuring the multipath communication protocol to distribute communications of the first application via a plurality of the connections.

3. The method of claim 2, wherein the communication parameter comprises a communication size of the first application; and further comprising configuring the multipath communication protocol to distribute communications of the first application via the plurality of the connections responsive to a determination that the communication size of the first application exceeds a predetermined threshold.

4. The method of claim 2, wherein the communication parameter comprises a quality of service (QoS) value for the first application; and further comprising configuring the multipath communication protocol to distribute communications of the first application via the plurality of the connections responsive to a determination that the QoS value for the first application exceeds a predetermined threshold.

5. The method of claim 4, wherein the communication parameter further comprises a reliability value for the first application; and further comprising configuring the multipath communication protocol to distribute communications of the first application via the plurality of the connections responsive to a determination that the reliability value for the first application is below a second predetermined threshold.

6. The method of claim 1, wherein applying the policy further comprises configuring the multipath communication protocol to duplicate communications of the first application via a plurality of the connections.

7. The method of claim 6, wherein the communication parameter further comprises a reliability value for the first application; and further comprising configuring the multipath communication protocol to distribute communications of the first application via the plurality of the connections responsive to a determination that the reliability value for the first application is above a predetermined threshold.

8. The method of claim 1, wherein applying the policy further comprises configuring the multipath communication protocol to steer communications of the first application via one of the plurality of the connections.

9. The method of claim 8, wherein the communication parameter comprises a communication size of the first application; and further comprising configuring the multipath communication protocol to steer communications of the first application via one of the plurality of the connections responsive to a determination that the communication size of the first application is below a predetermined threshold.

10. The method of claim 8, wherein the communication parameter comprises a quality of service (QoS) value for the first application; and further comprising configuring the multipath communication protocol to steer communications of the first application via one of the plurality of the connections responsive to a determination that the QoS value for the first application is below a predetermined threshold.

11. A system for intelligent aggregation and management of connections, comprising:
a device comprising a processor and a plurality of network interfaces, the processor configured for executing a first application and a connection manager, the device configured for:
establishing, for the first application, a first connection via a first interface of the plurality of network interfaces to a destination, and
establishing, for the first application, at least one additional connection via a corresponding at least one additional interface of the plurality of network interfaces to the destination; and
wherein the connection manager is configured for:
determining at least one communication parameter of the first application,
determining at least one connection parameter of each of the first connection and at least one additional connections, and
applying a policy to configure a multipath communication protocol, responsive to the determined at least one communication parameter of the first application and the determined at least one connection parameter of each of the first connection and at least one additional connections.

12. The system of claim 11, wherein the communication parameter comprises a communication size of the first application; and wherein the connection manager is further configured for configuring the multipath communication protocol to distribute communications of the first application via a plurality of the connections responsive to a determination that the communication size of the first application exceeds a predetermined threshold.

13. The system of claim 11, wherein the communication parameter comprises a quality of service (QoS) value for the first application; and wherein the connection manager is further configured for configuring the multipath communication protocol to distribute communications of the first application via a plurality of the connections responsive to a determination that the QoS value for the first application exceeds a predetermined threshold.

14. The system of claim 13, wherein the communication parameter further comprises a reliability value for the first application; and wherein the connection manager is further configured for configuring the multipath communication protocol to distribute communications of the first application via the plurality of the connections responsive to a determination that the reliability value for the first application is below a second predetermined threshold.

15. The system of claim 11, wherein the communication parameter further comprises a reliability value for the first application; and wherein the connection manager is further configured for configuring the multipath communication protocol to distribute communications of the first application via a plurality of the connections responsive to a determination that the reliability value for the first application is above a predetermined threshold.

16. The system of claim 11, wherein the communication parameter comprises a communication size of the first application; and wherein the connection manager is further configured for configuring the multipath communication protocol to steer communications of the first application via one of the plurality of the connections responsive to a determination that the communication size of the first application is below a predetermined threshold.

17. The system of claim 11, wherein the communication parameter comprises a quality of service (QoS) value for the first application; and wherein the connection manager is further configured for configuring the multipath communication protocol to steer communications of the first application via one of the plurality of the connections responsive to a determination that the QoS value for the first application is below a predetermined threshold.

18. The system of claim 11, wherein the first connection comprises a cellular connection.

19. A system for intelligent aggregation and management of connections, comprising:
a cellular communication interface;
a wireless communication interface; and
circuitry configured to
establish a first connection via the cellular communication interface with an application executed by a remote device,
establish a second connection via the wireless communication interface with the application executed by the remote device, and
communicate via the first connection and second connection with the application executed by the remote device according to a multipath communication policy selected according to at least one communication parameter of the first application.

20. The system of claim 19, wherein the circuitry is further configured to distribute communications with the application between the first connection and second connection responsive to a determination that (i) a communication size of the application exceeds a predetermined threshold, or (ii) a communication quality of service (QoS) value of the application exceeds a second predetermined threshold and a communication reliability value of the application is below a third predetermined threshold.
